(19) United States
(12) Patent Application Publication
(10) Pub. No.: US 2016/0240120 A1
(43) Pub. Date: Aug. 18, 2016

(54) Test Circuit and Display Panel

(71) Applicant: SHENZHEN CHINA STAR OPTOELECTRONICS TECHNOLOGY CO LTD., Shenzhen, Guangdong (CN)

(72) Inventor: Peng DU, Shenzhen, Guangdong (CN)

(73) Assignee: Shenzhen China Star Optoelectronics Technology Co. ,Ltd., Shenzhen, Guangdong (CN)

(21) Appl. No.: 14/379,803

(22) PCT Filed: May 16, 2014
(86) PCT No.: PCT/CN2014/077629

§ 371 Date: Aug. 20, 2014

(30) Foreign Application Priority Data
Mar. 19, 2014 (CN) 201410104128.2

(51) Int. Cl. G09G 3/00; G09G 3/36

(52) U.S. Cl. CPC G09G 3/006; G09G 3/3648; G09G 3/3696; G09G 2330/12; G09G 2330/04

(57) ABSTRACT

The embodiments of the present invention disclose a test circuit and a display panel, the test circuit comprises a test circuit first terminal, a test circuit second terminal, a test signal line, a voltage signal line, a switching transistor and a first electrostatic discharge protection circuit; the test signal line transmits the test signal, one end is connected with the first terminal, the other end is respectively connected with the switching transistor and the common electrode; the switching transistor is connected with the signal line, according to the received voltage signal on or off to conduct or cut off the test signal with signal line; the first electrostatic discharge protection circuit is respectively connected with the test signal line and signal line. To implement the embodiments, providing a test circuit and a display panel which occupy small space, it is conducive to the narrow border display panel design.

This application submitted to Chinese Patent Office on Mar. 19, 2014, application NO. is 201410104128.2, the title of the invention is China patent priority of “test circuit and display panel”, the entire contents of the patent are incorporated by reference in the present application.

### BACKGROUND OF THE INVENTION

1. Field of the Invention

The present invention relates to the display technical field, and in particular to a test circuit and a display panel.

2. The Related Arts

Thin Film Transistor-Liquid Crystal Display, TFT-LCD, which the traditional panel test circuit is directly connected with the signal line (such as gate line/data line) of the display panel, it needs for laser cutting process after completion of the test, cutting their connection, thus the display panel can be normally lit up, the traditional test method makes the producing cost higher.

In order to reduce the producing cost, the prior art usually uses TFT switching transistor as a switch, connecting the test circuit and the signal line of the internal display panel, adding a high voltage on the gate of TFT switching transistor, the TFT switching transistor turns on the test signal and the signal line of the internal display panel, after finishing the test, adding a low voltage on the gate of TFT switching transistor, turning off the test signal, cutting off the connection between the test circuit and the signal line of the internal display panel, the display panel can be in normal operation.

Through turning on and off the control test signal of the TFT switching transistor, which can eliminates the need for laser cutting process, achieving the purpose of cost saving, and the test traces keep away from the cutting line and edge grinding region, improving the process yield, but the test line is often located in the peripheral region of the display panel, after finishing the test, the test circuit left in the peripheral region of the display panel will occupy a part of the space. Therefore, it is very unfavorable to adopt the above design to the narrow border display panel.

### SUMMARY OF THE INVENTION

The technical problems to be solved in the embodiment of the present invention is to provide a small size test circuit and a display panel, which is conducive to a narrow border display panel design.

In order to solve the above technical issues, the first technical solution adopted by the present invention is: a test circuit, which is used for display panel, wherein the test circuit comprises a test circuit first terminal, a test circuit second terminal, a test signal line, a voltage signal line, a switching transistor and a first electrostatic discharge protection circuit;

Wherein, the test circuit first terminal is used to output a display panel test signal, the test circuit second terminal is used to output a voltage signal which turns on or turns off the switching transistor;

The test signal line is used to transmit the display panel test signal, one end is connected with the test circuit first terminal, and the other end is connected with the switching transistor and the common electrode;

The voltage signal line is used to transmit the voltage signal, one end is connected with the test circuit second terminal, and the other end is connected with the switching transistor;

The switching transistor is connected with the display panel signal line, which is used to receive the voltage signal output by the test circuit second terminal through the voltage signal line, and according to the received voltage signal on to conduct the test signal received by the test signal line and the display panel signal line, or the received voltage signal off to cut off the test signal and the display panel signal line;

The first electrostatic discharge protection circuit is respectively connected with the test signal line and the display panel signal line.

Wherein the voltage signal output by the test circuit second terminal comprises a high voltage signal and a low voltage signal.

Wherein when the voltage signal received by the switching transistor is high voltage signal, the switching transistor obtains a voltage greater than the first predetermined value and turns on, making the test signal transmitted from the test signal line connect with signal line of the display panel; when the voltage signal received by the switching transistor is low voltage signal, the switching transistor obtains a voltage less than the second predetermined value and turns off, making the test signal disconnect with the signal line of the display panel.

Wherein the signal line of the display panel is data line or gate line.

Wherein the first electrostatic discharge protection circuit comprises a first transistor and a second transistor; wherein the gate and the drain of the first transistor are connected with the test signal line, the source is connected with the signal line of the display panel; the gate and the drain of the second transistor are connected with data line of the display panel, the source is connected with the test signal line; the first transistor and the second transistor form a communicated loop.

Wherein the first electrostatic discharge protection circuit further comprises a first diode and a second diode; wherein the positive electrode of the first diode is connected with the test signal line, the negative electrode is connected with the signal line of the display panel; the positive electrode of the second diode is connected with the signal line of the display panel, the negative electrode is connected with the test signal line; the first diode and the second diode are formed a communication circuit.

Wherein the test circuit also comprises a second electrostatic discharge protection circuit, which is disposed on the test signal line, one end is connected with the common electrode, and the other end is connected with the switching transistor and the test circuit first terminal.

Wherein the second electrostatic discharge protection circuit comprises a third transistor and a fourth transistor; wherein the gate and the drain of the third transistor are connected with the test signal line, the source of the third transistor is connected with the gate and the drain of the fourth transistor, the source of the fourth transistor is connected with the common electrode; the third transistor and the fourth transistor are formed a communication circuit.

In order to solve the above technical issues, the second technical solution adopted by the present invention is: a test circuit, which is used for display panel, wherein the test circuit comprises a test circuit first terminal, a test circuit second terminal, a test signal line, a voltage signal line, a switching transistor and a driving chip processing unit;

Wherein, the test circuit first terminal is used to output a display panel test signal, the test circuit second terminal is used to output a voltage signal which turns on or turns off the switching transistor;

The test signal line is used to transmit the display panel test signal, one end is connected with the test circuit first terminal, and the other end is respectively connected with the switching transistor and the driving chip processing unit;

The voltage signal line is used to transmit the voltage signal, one end is connected with the test circuit second terminal, and the other end is connected with the switching transistor;

The switching transistor is connected with the display panel signal line, which is used to receive the voltage signal output by the test circuit second terminal through the voltage signal line, and according to the received voltage signal on to conduct the test signal received by the test signal line and the display panel signal line, or the received voltage signal off to cut off the test signal and the display panel signal line;

The driving chip processing unit comprises at least one driving chip, which is used to output the related signal of the display panel.

Wherein the driving chip processing unit comprises a plurality driving chips, and when each driving chips is connected to each other through a wire on array, the test signal line is also connected with the wire on array between each driving chips.

Wherein the voltage signal output by the test circuit second terminal comprises a high voltage signal and a low voltage signal.

Wherein when the voltage signal received by the switching transistor is high voltage signal, the switching transistor obtains a voltage greater than the first predetermined value and turns on, making the test signal transmitted from the test signal line connect with signal line of the display panel; when the voltage signal received by the switching transistor is low voltage signal, the switching transistor obtains a voltage less than the second predetermined value and turns off, making the test signal disconnect with the signal line of the display panel.

Wherein the signal line of the display panel is data line or gate line.

In order to solve the above technical issues, the third technical solution adopted by the present invention is: a display panel, wherein it comprises a test circuit;

The test circuit comprises a test circuit first terminal, a test circuit second terminal, a test signal line, a voltage signal line, a switching transistor and a first electrostatic discharge protection circuit;

Wherein, the test circuit first terminal is used to output a display panel test signal, the test circuit second terminal is used to output a voltage signal which turns on or turns off the switching transistor;

The test signal line is used to transmit the display panel test signal, one end is connected with the test circuit first terminal, and the other end is connected with the switching transistor and the common electrode;

The voltage signal line is used to transmit the voltage signal, one end is connected with the test circuit second terminal, and the other end is connected with the switching transistor;

The switching transistor is connected with the display panel signal line, which is used to receive the voltage signal output by the test circuit second terminal through the voltage signal line, and according to the received voltage signal on to conduct the test signal received by the test signal line and the display panel signal line, or the received voltage signal off to cut off the test signal and the display panel signal line;

The first electrostatic discharge protection circuit is respectively connected with the test signal line and the display panel signal line.

Wherein the voltage signal output by the test circuit second terminal comprises a high voltage signal and a low voltage signal.

Wherein when the voltage signal received by the switching transistor is high voltage signal, the switching transistor obtains a voltage greater than the first predetermined value and turns on, making the test signal transmitted from the test signal line connect with signal line of the display panel; when the voltage signal received by the switching transistor is low voltage signal, the switching transistor obtains a voltage less than the second predetermined value and turns off, making the test signal disconnect with the signal line of the display panel.

Wherein the signal line of the display panel is data line or gate line.

Wherein the first electrostatic discharge protection circuit comprises a first transistor and a second transistor; wherein the gate and the drain of the first transistor are connected with the test signal line, the source is connected with the signal line of the display panel; the gate and the drain of the second transistor are connected with data line of the display panel, the source is connected with the test signal line; the first transistor and the second transistor form a communicated loop.

Wherein the first electrostatic discharge protection circuit further comprises a first diode and a second diode; wherein the positive electrode of the first diode is connected with the test signal line, the negative electrode is connected with the signal line of the display panel; the positive electrode of the second diode is connected with the signal line of the display panel, the negative electrode is connected with the test signal line; the first diode and the second diode are formed a communication circuit.

Wherein the test circuit also comprises a second electrostatic discharge protection circuit, which is disposed on the test signal line, one end is connected with the common electrode, and the other end is connected with the switching transistor and the test circuit first terminal.

The test circuit and the display panel provided by the present invention has the following benefits:

1. Since the test signal line and the discharge trace of the electrostatic discharge protection circuit are multiplexed, it can transmit the test signal during test, the electrostatic produced by signal line (data line/gate line) of the display panel is immediately released after finishing test, it doesn't have to individually design the ESD protection circuit, effectively reducing the size of the external traces of the display panel, it is conducive to a narrow border display panel design.

2. Since the test signal line and external trace of the driving chip processing unit are multiplexed, it can effectively reduce the size of the external traces of the display panel, it also can be simultaneously connected with the wire on array between the multiple driving chips in the driving chip process unit, turning on these signals output by driving chips (in particular to several important signals, such as high voltage signal, low voltage signal, output control signal and so on), thereby increasing the width between the wire on arrays of each driver chips, reducing the impedance of these signal traces, avoiding the decline in display quality due to the greater impedance and a variety of color issues.

### BRIEF DESCRIPTION OF THE DRAWINGS

FIG. 1 is a structure diagram of external region design of the display panel in the prior art;

FIG. 2 is a structure diagram of external region design of the display panel provided by the present invention;

FIG. 3 is a connection schematic diagram of the test circuit provided by the first embodiment of the present invention;

FIG. 4 is a physical connection schematic diagram of the electrostatic discharge protection circuit constructed by two switching transistors of the test circuit provided by the first embodiment of the present invention;

FIG. 5 is a physical connection schematic diagram of the electrostatic discharge protection circuit constructed by two diodes of the test circuit provided by the first embodiment of the present invention;

FIG. 6 is a connection schematic diagram of the test circuit provided by the second embodiment of the present invention.

### DETAILED DESCRIPTION OF THE PREFERRED EMBODIMENTS

The following reference drawings describe the preferred embodiments of the present invention.

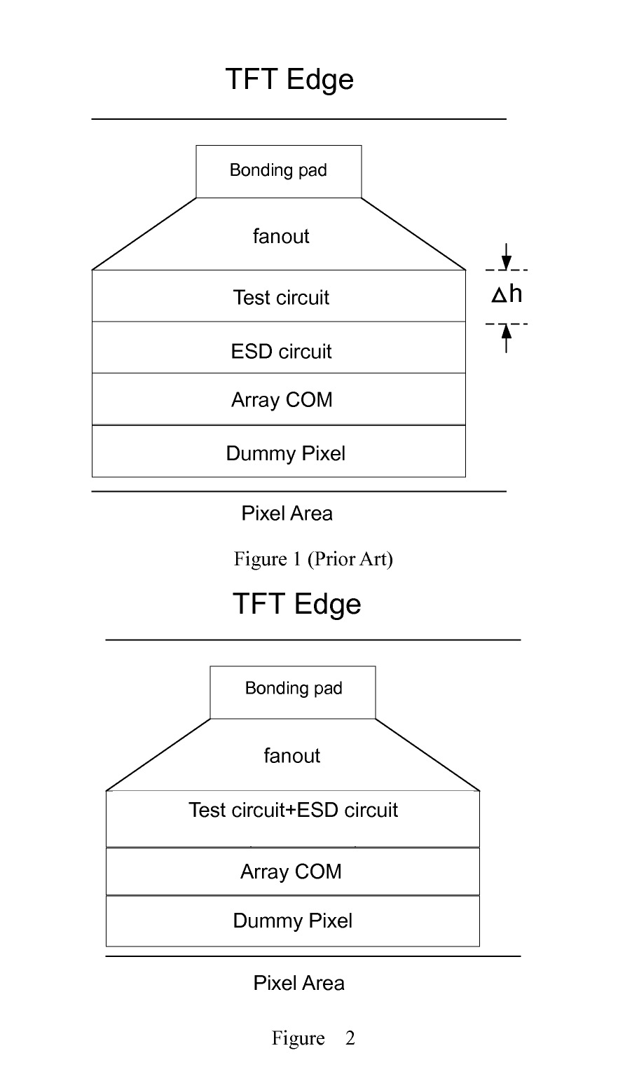

Referring to FIG. 1, as described above, the inventor discovered that in the external region design of the display panel in the prior art, the formation from inside to outside of the display panel sequentially is a dummy pixel, an array COM, a ESD circuit and a test circuit, this cabling method occupies a certain space, it is particularly not conducive to a narrow border display panel design.

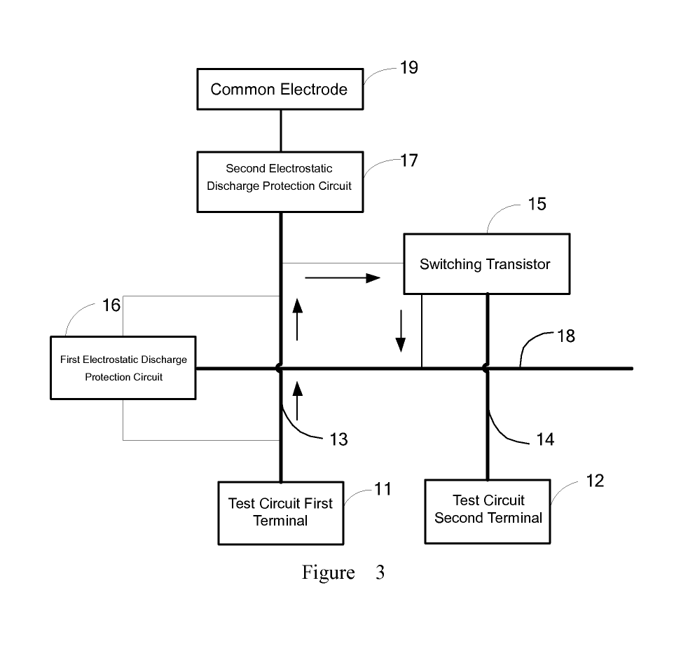

Therefore, the inventor provided a new design of display panel external region, merging the test line and the electrostatic discharge protection circuit line, it makes the space occupied less, it is very favorable to the narrow border display panel design, referring to FIG. 2, it reduces the width occupied by Δh in FIG. 1.

In order to achieving the new design of display panel external region as described above, merging the test line and the electrostatic discharge protection circuit line, it makes the space occupied less, it is very favorable to the narrow border display panel design, the inventor provides a test circuit and a display panel.

Referring to FIG. 3 to FIG. 6, which are embodiments of test circuit of the present invention.

As shown in FIG. 3, which is a connection schematic diagram of the test circuit provided by the first embodiment of the present invention. The test circuit in the embodiment of the present invention is used for display panel, which comprises a test circuit first terminal 11, a test circuit second terminal 12, a test signal line 13, a voltage signal line 14, a switching transistor 15 and a first electrostatic discharge protection circuit 16; wherein,

The test circuit first terminal 11 is used to output a display panel test signal, the test circuit second terminal 12 is used to output a voltage signal which turns on or turns off the switching transistor 15;

The test signal line 13 is used to transmit the display panel test signal, one end is connected with the test circuit first terminal 11, and the other end is connected with the switching transistor 15 and the common electrode 19;

The voltage signal line 14 is used to transmit the voltage signal, one end is connected with the test circuit second terminal 12, and the other end is connected with the switching transistor 15;

The switching transistor 15 is connected with the display panel signal line 18, which is used to receive the voltage signal 14 output by the test circuit second terminal 12 through the voltage signal line, and according to turn on the received voltage signal to conduct the test signal received by the test signal line 13 and the display panel signal line 18, or the received voltage signal off to cut off the test signal and the display panel signal line 18;

The first electrostatic discharge protection circuit 16 is respectively connected with the test signal line 13 and the display panel signal line 18.

The voltage signal output by the test circuit second terminal 12 comprises high voltage signal and low voltage signal, the signal line 18 on the display panel is data line or gate line.

Specifically, the gate of the switching transistor 15 is connected with the voltage signal line 14, when the voltage signal received by the switching transistor is high, the switching transistor 15 obtains a voltage greater than a first default value and turns on, making the test signal transmitted from the test signal line 13 conducted with the signal line 18 of the display panel (as the arrow shown in FIG. 3); when the voltage signal received by the switching transistor 15 is low, the switching transistor 15 obtains a voltage less than a second default value and turns off, making the test signal cut off with the signal line 18 of the display panel. Wherein the first default value is positive, the second default value is negative.

Furthermore, the test circuit also comprises a second electrostatic discharge protection circuit 17, which is disposed on the test signal line 13, one end is connected with the common electrode 19, and the other end is connected with the switching transistor 15 and the test circuit first terminal 11, the second electrostatic discharge protection circuit 17 is not only used to protect the electrostatic discharge on the signal line 18 of the display panel after finishing the test, but also used to protect the electrostatic discharge on the voltage signal line 14.

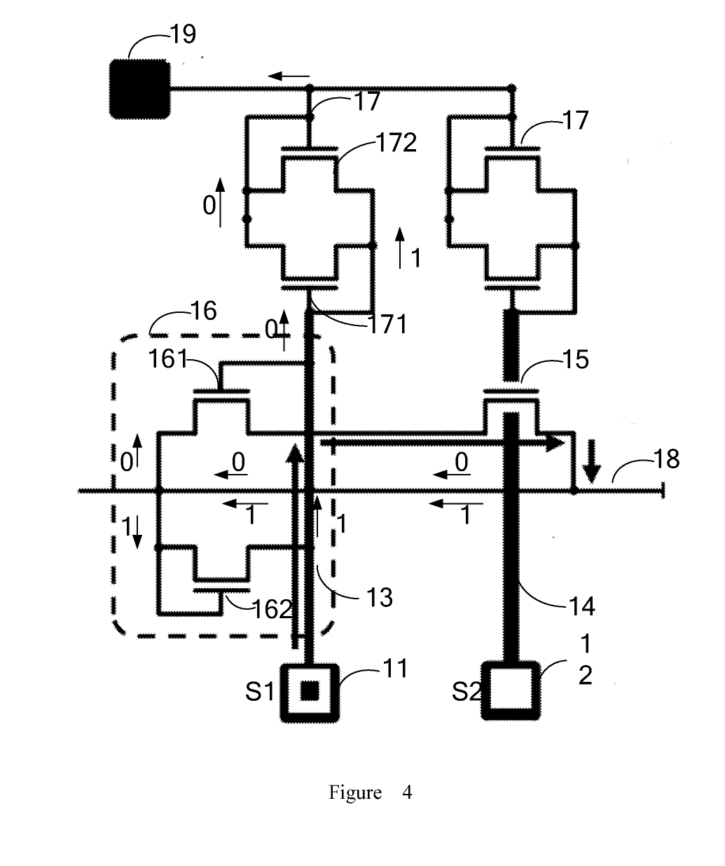

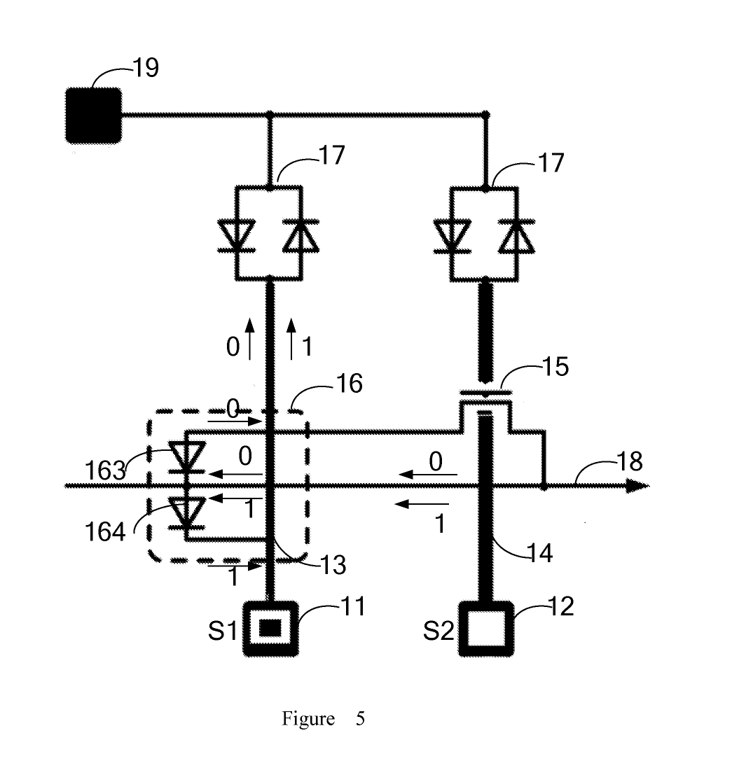

The first electrostatic discharge protection circuit 16 and the second electrostatic discharge protection circuit 17 are formed an annular circuit by two transistors or two diodes. Please referring to FIG. 4, taking the first electrostatic discharge protection circuit 16 for example, which comprises a first transistor 161 and a second transistor 162, wherein the gate and drain of the first transistor 161 on the top are connected with the test signal line 13, the source is connected with the signal line 18, the gate and the drain of the second transistor 162 on the bottom are connected with the signal lien 18, the source is connected with test signal line 13. Under this connection, as long as the drain voltage of the first transistor and the second transistor in the first electrostatic discharge protection circuit 16 is higher than the source voltage, because of the connection of gate and drain, the gate voltage is also higher than the source voltage and will turn on; otherwise, it will turn off, this characteristic is the same as the diode, so it can be alternated by the diode. Referring to FIG. 5, taking the first electrostatic discharge protection circuit 16 for example, which comprises a first diode 163 and a second diode 164; wherein the positive electrode of the first diode 163 is connected with the test signal line 13, the negative electrode is connected with the signal line 18 of the display panel; the positive electrode of the second diode 164 is connected with the signal line 18 of the display panel, the negative electrode is connected with the test signal line 13, the resistances of the first diode 163 and the second diode 164 in the first electrostatic discharge protection circuit 16 are big enough, it won't affect the panel test and normal operation.

Similarly, The second electrostatic discharge protection circuit 17 is also used two transistors, please referring to FIG. 4, taking the two transistors in the second electrostatic discharge protection circuit 17 on the left side of FIG. 4 for example, which comprises a third transistor 171 and a fourth transistor 172; wherein, the gate and drain of the third transistor 171 are connected with the test signal line 13, the source of the third transistor 171 is connected with the gate and drain of the fourth transistor 172, the source of the fourth transistor 172 is also connected with the common electrode 19. Similarly, the two transistors in the second electrostatic discharge protection circuit 17 also can be alternated by the diodes (as shown in FIG. 5), the principle that two diodes alternate the two transistors is the same as in the first electrostatic discharge protection circuit 16, there will be no more description.

There combines FIG. 4 and FIG. 5 to describe the working principle of the test circuit in the first embodiment of the present invention;

When the voltage signal S2 is 30V, the gate of switching transistor 15 obtains 30V and turns on, control test signal 51 conducts to the signal line 18 of the display panel (as solid arrow shown in FIG. 4) to do normal test.

After finishing the test, the test circuit second terminal 12 outputs −6V, the gate of the switching transistor 15 obtains −16V and turns off, the control test signal 51 turns off. At this time, the first electrostatic discharge protection circuit 16 receives the electrostatic released from signal line 18, when the electrostatic is positive, because the gate and drain of the second switching transistor 162 are connected with signal line 18, the source is connected with the test signal line 13, the positive electrostatic will turn on the second switching transistor 162, and the first transistor 161 is cut off, the electrostatic is released from the second transistor 162 to the test signal line 13 (as arrow 1 shown in FIG. 4, 1 represents a positive charge); when the electrostatic is negative charge, since the gate and drain of the first transistor 161 are connected with the test signal line 13, the source is connected with the signal line 18; therefore, the negative electrostatic will turn on the first transistor 161, and the second transistor 162 is cut off, the electrostatic is released from the first transistor 161 to the test signal 13 (as arrow 0 shown in FIG. 4, 0 represents negative charge). It can be seen that the test signal line 13 in the present embodiment is multiplexed as a discharge circuit of the electrostatic discharge protection circuit, it does not only transmit the test signal, but also be a electrostatic discharge protection. The electrostatic reaches the common electrode 19 through the second electrostatic discharge protection circuit 17; likewise, the function of the two transistors of the second electrostatic discharge protection circuit 17 is the same with the two transistor 161 and 162 of the first electrostatic discharge protection circuit 16.

Similarly, when utilizing the diode to alternate the switching transistor, because the resistance of the diode in the circuit is big enough, it won't influence the panel test and the normal operation; therefore, it also can be the same effect of electrostatic discharge protection, wherein the meanings of 0 and 1 in FIG. 5 are the same with 0 and 1 in FIG. 4.

Corresponding to the test circuit in the first embodiment of the present invention, it also provides a display panel, which comprises the test circuit in the first embodiment of the present invention, the structure and the connection of the test circuit are the same with the test circuit in the first embodiment of the present invention, please refer to FIG. 3 to FIG. 5, there will be no more description.

According to the description of above embodiment, since the test signal line and the discharge traces of the electrostatic discharge protection are multiplexed, it can transmit the test signal during the test, and immediately releasing the electrostatic generated by the signal line (data line/gate line) in the display panel after finishing the test, there is no need to individually design the ESD protection circuit, effectively decreasing the size of the external traces of the display panel, it is conducive to the narrow border display panel design.

The inventor also discovered that in the other display panel design in the prior art, the common electrode traces on the source side and gate side of display panel are parallel with the test circuit, this cabling method also occupies some space, it is not conducive to the narrow border display panel design.

Therefore, the inventor provides a new cabling method again, merging the test circuit and the common electrode traces, which occupies less space, it is conducive to the narrow border display panel design. Corresponding to the new cabling method provides a test circuit and a display panel.

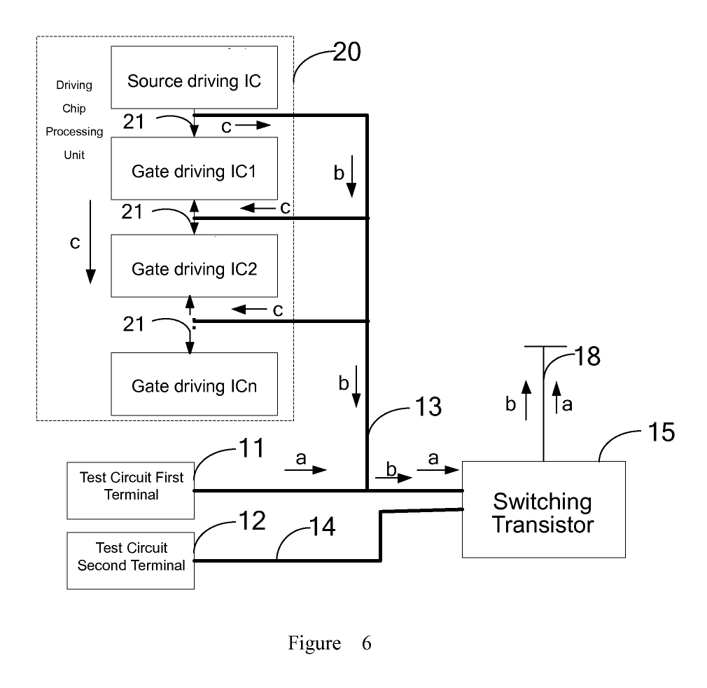

As shown in FIG. 6, which is a connection schematic diagram of the test circuit provided by the second embodiment of the present invention. The test circuit in the embodiment of the present invention is used for display panel, which comprises a test circuit first terminal 11, a test circuit second terminal 12, a test signal line 13, a voltage signal line 14, a switching transistor 15 and a driving chip processing unit 20; wherein,

The test circuit first terminal 11 is used to output a display panel test signal, the test circuit second terminal 12 is used to output a voltage signal which turns on or turns off the switching transistor 15;

The test signal line 13 is used to transmit the display panel test signal, one end is connected with the test circuit first terminal 11, and the other end is respectively connected with the switching transistor 15 and the driving chip processing unit 20;

The voltage signal line 14 is used to transmit the voltage signal, one end is connected with the test circuit second terminal 12, and the other end is connected with the switching transistor 15;

The switching transistor 15 is connected with the display panel signal line 18, which is used to receive the voltage signal output by the test circuit second terminal 12 through the voltage signal line 14, and according to the received voltage signal on to conduct the test signal received by the test signal line 13 and the display panel signal line 18, or the received voltage signal off to cut off the test signal and the display panel signal line 18;

The driving chip processing unit 20 comprises at least one driving chip, which is used to output the related signal of the display panel, the signal comprises a high voltage signal provided by the driving chip, a low voltage signal, an output control signal and so on.

The driving chip processing unit 20 comprises a plurality driving chips, and when each driving chips is connected to each other through a wire on array, WOA, the test signal line 13 is also connected with the wire on array between each driving chips, which can conduct the signal output these diving chips, thereby increasing the width of the wires on array between each driving chips, reducing the resistance of these signal traces, avoiding the decline in display quality due to the greater impedance and a variety of color issues.

The voltage signal output by the test circuit second terminal 12 comprises a high voltage signal and a low voltage signal, the signal line 18 of the display panel is data line or gate line.

Specifically, the gate of the switching transistor 15 is connected with the voltage signal line 14, when the voltage signal received by the switching transistor is high, the switching transistor 15 obtains a voltage greater than a first default value and turns on, making the test signal transmitted from the test signal line 13 conducted with the signal line 18 of the display panel; when the voltage signal received by the switching transistor 15 is low, the switching transistor 15 obtains a voltage less than a second default value and turns off, making the test signal cut off with the signal line 18 of the display panel. Wherein the first default value is positive, the second default value is negative.

The working principle of the test circuit in the second embodiment of the present invention is: because the display panel has no bonding during the test, there will be no driving voltage on the driving chip of the of the driving chip process unit 20, the switching transistor 15 turns on, the control test signal conducts to the signal line 18 of the display panel (as arrow a shown in FIG. 6), lighting up the display panel and detecting; after finishing the test, the display panel begins the boding process, at this time, the switching transistor 15 turns off, the control test signal and the signal line 18 of the display panel turn off. The test signal line 13 is as the external common electrode trace of the driving chip processing unit 20, making the driving chip in the driving chip processing unit 20 able to provide the related signal for display panel (as arrow b shown in FIG. 6), when a plurality of driving chips in the driving chip processing unit 20 are connected with each other, the test signal line 13 can not only be the external common electrode of the driving chip processing unit 20, but also used to be the wires on array 21 (as arrow c shown in FIG. 6) between each driving chips, increasing the trace width between each driving chips.

Corresponding to the test circuit in the second embodiment of the present invention also provides a display panel, which comprises the test circuit in the second embodiment of the present invention, the test circuit is the same with the structure and connection of the test circuit in the second embodiment of the present invention, please refer to FIG. 6, there will be no more description.

According to the above description of the embodiment, because the test circuit and the external trace of the driving chip processing unit are multiplexed, it can effectively decrease the size of the external trace of the display panel, and also can simultaneously connect with the wires on array between the multiple driving chips in the driving chip processing unit, conducting the signals (in particular to some important signals, such as high voltage signal, low voltage signal, output control signal, etc.) output by these driving chips, thereby increasing the width of the wires on array between each driving chips, reducing the resistance of these signal trace, avoiding the decline in display quality due to the greater impedance and a variety of color issues.

The ordinary technical personnel in the art can understand that all or part of the steps of the above embodiments can be accomplished through a program instructing the related hardware, the program can be stored in the readable storage medium of a computer, the storage medium, such as ROM/RAM, disk, optical disk, etc.

The preferred embodiments according to the present invention are mentioned above, which cannot be used to define the scope of the right of the present invention. Those variations of equivalent structure or equivalent process according to the present specification and the drawings or directly or indirectly applied in other areas of technology are considered encompassed in the scope of protection defined by the claims of the present invention.

What is claimed is:

1. A test circuit, which is used for display panel, wherein the test circuit comprises a test circuit first terminal, a test circuit second terminal, a test signal line, a voltage signal line, a switching transistor and a first electrostatic discharge protection circuit; wherein,
The test circuit first terminal is used to output a display panel test signal, the test circuit second terminal is used to output a voltage signal which turns on or turns off the switching transistor;
The test signal line is used to transmit the display panel test signal, one end is connected with the test circuit first terminal, and the other end is connected with the switching transistor and the common electrode;
The voltage signal line is used to transmit the voltage signal, one end is connected with the test circuit second terminal, and the other end is connected with the switching transistor;
The switching transistor is connected with the display panel signal line, which is used to receive the voltage signal output by the test circuit second terminal through the voltage signal line, and according to the received voltage signal on to conduct the test signal received by the test signal line and the display panel signal line, or the received voltage signal off to cut off the test signal and the display panel signal line;
The first electrostatic discharge protection circuit is respectively connected with the test signal line and the display panel signal line.

2. The test circuit as claimed in claim 1, wherein the voltage signal output by the test circuit second terminal comprises a high voltage signal and a low voltage signal.

3. The test circuit as claimed in claim 2, wherein when the voltage signal received by the switching transistor is high voltage signal, the switching transistor obtains a voltage greater than the first predetermined value and turns on, making the test signal transmitted from the test signal line connect with signal line of the display panel; when the voltage signal received by the switching transistor is low voltage signal, the switching transistor obtains a voltage less than the second predetermined value and turns off, making the test signal disconnect with the signal line of the display panel.

4. The test circuit as claimed in claim 1, wherein the signal line of the display panel is data line or gate line.

5. The test circuit as claimed in claim 1, wherein the first electrostatic discharge protection circuit comprises a first transistor and a second transistor; wherein the gate and the drain of the first transistor are connected with the test signal line, the source is connected with the signal line of the display panel; the gate and the drain of the second transistor are connected with data line of the display panel, the source is connected with the test signal line; the first transistor and the second transistor form a communicated loop.

6. The test circuit as claimed in claim 1, wherein the first electrostatic discharge protection circuit further comprises a first diode and a second diode; wherein the positive electrode of the first diode is connected with the test signal line, the negative electrode is connected with the signal line of the display panel; the positive electrode of the second diode is connected with the signal line of the display panel, the negative electrode is connected with the test signal line; the first diode and the second diode are formed a communication circuit.

7. The test circuit as claimed in claim 1, wherein the test circuit also comprises a second electrostatic discharge protection circuit, which is disposed on the test signal line, one end is connected with the common electrode, and the other end is connected with the switching transistor and the test circuit first terminal.

8. The test circuit as claimed in claim 7, wherein the second electrostatic discharge protection circuit comprises a third transistor and a fourth transistor; wherein the gate and the drain of the third transistor are connected with the test signal line, the source of the third transistor is connected with the gate and the drain of the fourth transistor, the source of the fourth transistor is connected with the common electrode; the third transistor and the fourth transistor are formed a communication circuit.

9. A test circuit, which is used for display panel, wherein the test circuit comprises a test circuit first terminal, a test circuit second terminal, a test signal line, a voltage signal line, a switching transistor and a first electrostatic discharge protection circuit; wherein,
The test circuit first terminal is used to output a display panel test signal, the test circuit second terminal is used to output a voltage signal which turns on or turns off the switching transistor;
The test signal line is used to transmit the display panel test signal, one end is connected with the test circuit first terminal, and the other end is respectively connected with the switching transistor and the driving chip processing unit;
The voltage signal line is used to transmit the voltage signal, one end is connected with the test circuit second terminal, and the other end is connected with the switching transistor;
The switching transistor is connected with the display panel signal line, which is used to receive the voltage signal output by the test circuit second terminal through the voltage signal line, and according to the received voltage signal on to conduct the test signal received by the test signal line and the display panel signal line, or the received voltage signal off to cut off the test signal and the display panel signal line;
The driving chip processing unit comprises at least one driving chip, which is used to output the related signal of the display panel.

10. The test circuit as claimed in claim 9, wherein the driving chip processing unit comprises a plurality driving chips, and when each driving chips is connected to each other through a wire on array, the test signal line is also connected with the wire on array between each driving chips.

11. The test circuit as claimed in claim 9, wherein the voltage signal output by the test circuit second terminal comprises a high voltage signal and a low voltage signal.

12. The test circuit as claimed in claim 11, wherein when the voltage signal received by the switching transistor is high voltage signal, the switching transistor obtains a voltage greater than the first predetermined value and turns on, making the test signal transmitted from the test signal line connect with signal line of the display panel; when the voltage signal received by the switching transistor is low voltage signal, the switching transistor obtains a voltage less than the second predetermined value and turns off, making the test signal disconnect with the signal line of the display panel.

13. The test circuit as claimed in claim 9, wherein the signal line of the display panel is data line or gate line.

14. A display panel, wherein it comprises a test circuit; the test circuit comprises a test circuit first terminal, a test circuit second terminal, a test signal line, a voltage signal line, a switching transistor and a first electrostatic discharge protection circuit; wherein,
The test circuit first terminal is used to output a display panel test signal, the test circuit second terminal is used to output a voltage signal which turns on or turns off the switching transistor;
The test signal line is used to transmit the display panel test signal, one end is connected with the test circuit first terminal, and the other end is connected with the switching transistor and the common electrode;
The voltage signal line is used to transmit the voltage signal, one end is connected with the test circuit second terminal, and the other end is connected with the switching transistor;
The switching transistor is connected with the display panel signal line, which is used to receive the voltage signal output by the test circuit second terminal through the voltage signal line, and according to the received voltage signal on to conduct the test signal received by the test signal line and the display panel signal line, or the received voltage signal off to cut off the test signal and the display panel signal line;
The first electrostatic discharge protection circuit is respectively connected with the test signal line and the display panel signal line.

15. The display panel as claimed in claim 14, wherein the voltage signal output by the test circuit second terminal comprises a high voltage signal and a low voltage signal.

16. The display panel as claimed in claim 15, wherein when the voltage signal received by the switching transistor is high voltage signal, the switching transistor obtains a voltage greater than the first predetermined value and turns on, making the test signal transmitted from the test signal line connect with signal line of the display panel; when the voltage signal received by the switching transistor is low voltage signal, the switching transistor obtains a voltage less than the second predetermined value and turns off, making the test signal disconnect with the signal line of the display panel.

17. The display panel as claimed in claim 14, wherein the signal line of the display panel is data line or gate line.

18. The display panel as claimed in claim 14, wherein the first electrostatic discharge protection circuit comprises a first transistor and a second transistor; wherein the gate and the drain of the first transistor are connected with the test signal line, the source is connected with the signal line of the display panel; the gate and the drain of the second transistor are connected with data line of the display panel, the source is connected with the test signal line; the first transistor and the second transistor form a communicated loop.

19. The display panel as claimed in claim 14, wherein the first electrostatic discharge protection circuit further comprises a first diode and a second diode; wherein the positive electrode of the first diode is connected with the test signal line, the negative electrode is connected with the signal line of the display panel; the positive electrode of the second diode is connected with the signal line of the display panel, the negative electrode is connected with the test signal line; the first diode and the second diode are formed a communication circuit.

20. The display panel as claimed in claim 14, wherein the test circuit also comprises a second electrostatic discharge protection circuit, which is disposed on the test signal line, one end is connected with the common electrode, and the other end is connected with the switching transistor and the test circuit first terminal.
